(19) United States
(12) Patent Application Publication
(10) Pub. No.: US 2007/0251097 A1
(43) Pub. Date: Nov. 1, 2007

(54) Feeding utensil with audio component

(75) Inventor: John Terry, Miami Shores, FL (US)

Correspondence Address: Mark Terry;Suite 500, 2250 SW 3rd Av., Miami, FL, 33129, US

(73) Assignee: Apples & Bananas, LLC

(21) Appl. No.: 11/412,772

(22) Filed: Apr. 27, 2006

(51) Int. Cl. B26B 11/00

(52) U.S. Cl. 30/123

(57) ABSTRACT

A utensil for feeding a child is disclosed. The utensil includes a portion for holding food and a handle for holding the utensil. The utensil further includes a speaker for playing audio and at least one activator for activating the speaker to play audio. The portion for holding food may be removable and may include a fork or a spoon. Further, the portion for holding food may be a concave basin portion or two or more prongs for pitching food. Also, the activator may include one ore more buttons and the utensil may include a processor connected to one or more buttons, wherein the processor activates playing of audio via the speaker when at least one button is pushed. Additionally, the utensil may include a memory for storing audio data, wherein the processor reads the audio data and plays it via the speaker when a button is pushed.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

This invention relates to eating utensils, and more particularly to features for eating utensils that make the eating experience more appealing to infants and children.

### BACKGROUND OF THE INVENTION

As any parent knows, feeding an infant or a child can be time-consuming, messy and stressful. Children often do not want to eat or get easily distracted or bored during the feeding process. As such, parents often dread this procedure and concoct various methods for keeping the child interested and engaged during feeding.

One approach to this problem is the creation of little games or amusements where eating is made part of the entertainment. A well-known and time-tested method for keeping a child focused during feeding is by pretending the utensil, with food piled on it, is a vehicle such as a train or a truck that is headed for the child's mouth. Typically, the feeder will load the food on the utensil and then slowly inch the utensil closer to the child's mouth as the feeder makes a “choo-choo” sound or the sound of any other vehicle. As the utensil nears the child's mouth, he eagerly waits for the opportunity to receive the food and eat the vehicle. Children enjoy this game and it holds the attention of the child during eating. Parents and babysitters, however, often get tired of making the vehicle sound and either stop making the sound altogether or simply do not make the sound with the same enthusiasm as they did when they started feeding. This can be discouraging for the child who may then revert to his previously distracted or unfocused state.

Another common approach to keeping a child engaged during feeding is to give a reward to the child when he finishes eating. This transforms the eating experience into a goal oriented procedure that often keeps a child interested during the process. Sometimes, however, children lose sight of the goal and slip back into a distracted state. Further, parents sometimes forget to give the child his reward, thereby discouraging the youngster from seeking the goal in the future.

Therefore, a need exists to overcome the problems with the prior art as discussed above, and particularly for a more efficient way for holding the attention of children during feeding.

### SUMMARY OF THE INVENTION

Briefly, according to an embodiment of the present invention, a utensil for feeding a child is disclosed. The utensil includes a portion for holding food and a handle for holding the utensil. The utensil further includes a speaker for playing audio and at least one activator for activating the speaker to play audio. The portion for holding food may be removable and may include any one of a fork and a spoon. Further, the portion for holding food may be a concave basin portion or two or more prongs for pitching food. Also, the activator may include one ore more buttons and the utensil may include a processor connected to one or more buttons, wherein the processor activates playing of audio via the speaker when at least one button is pushed. Additionally, the utensil may include a memory for storing audio data, wherein the processor reads the audio data and plays it via the speaker when a button is pushed.

In another embodiment of the present invention, a utensil for feeding a child is disclosed. The utensil includes a portion for holding food and a handle for holding the utensil. The utensil further includes a memory for storing audio data and a speaker for playing the audio data. The utensil further includes a processor for playing the audio data via the speaker when activated. The portion for holding food may be removable and may include any one of a fork and a spoon. Further, the utensil may include at least one button for instructing the processor to activate playing the audio data via the speaker when at least one button is pushed. Additionally, the audio data may include sounds made by a vehicle.

In another embodiment of the present invention, an apparatus for feeding a child is disclosed. The apparatus includes a utensil for holding food and an electrical unit for playing audio when activated. The utensil may include any one of a spoon and a fork. The electrical unit may further include a memory for holding audio data, a speaker for playing the audio data and at least one button for activating playing of the audio data via the speaker. The electrical unit may further include a processor for activating playing of the audio data via the speaker when at least one button is pushed. The electrical unit may further include a battery for providing power to the electrical unit.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is an illustration of a frontal view of an eating utensil including an audio component, according to one embodiment of the present invention.

FIG. 2 is an illustration of a side view of the eating utensil of FIG. 1.

FIG. 3 is an illustration of a frontal view of various attachments that can be appended to an eating utensil, according to one embodiment of the present invention.

FIG. 4 is an illustration of a frontal view of another eating utensil including an audio component, according to one embodiment of the present invention.

FIG. 5 is an illustration of a side perspective view of a bowl including a reward component, according to one embodiment of the present invention.

FIG. 6 is an illustration of a top perspective view of the bowl of FIG. 5.

FIG. 7 is an illustration of a bottom perspective view of the bowl of FIG. 5 shown in a disassembled state.

FIG. 8 is a block diagram depicting an electrical system for an eating utensil including an audio component.

### DETAILED DESCRIPTION

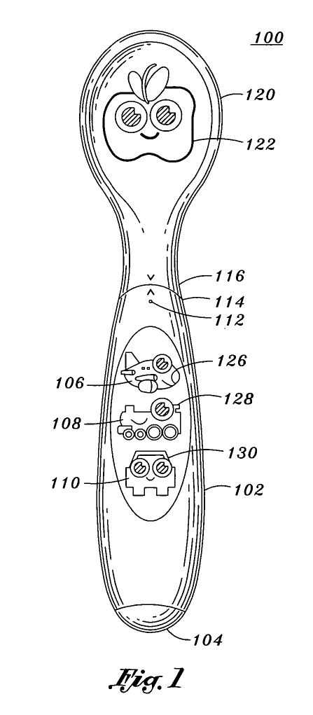

FIG. 1 is an illustration of a frontal view of an eating utensil 100 including an audio component, according to one embodiment of the present invention. FIG. 1 shows the upper portion 116 of the utensil 100 includes a concave basin-shaped portion 120 for holding food. The concave basin-shaped portion 120 is shaped like a spoon and is useful for scooping or picking up solid or liquid food for feeding to a person or child. The concave basin-shaped portion 120 includes a graphic 122 that serves to make the utensil 100 more aesthetic and entertain or focus the attention of the child eating from the utensil 100. In one embodiment of the present invention, the upper portion 116 includes two or more prongs or tines for pitching food, such as a fork. In another embodiment of the present invention, the upper portion 116 is manufactured from a soft, elastic and/or flexible material that is child-safe and protects sensitive portions of an individual's mouth, such as the gums or the tongue. For example, the upper portion 116 may be manufactured from an elastomer such as synthetic rubber, organic rubber or silicone rubber.

The upper portion 116 is detachable at and is secured onto bottom portion 102 of the utensil 100 at the junction 114. The bottom portion 102 of the utensil 100 includes buttons 106, 108 and 110. On top of each button, a graphic is affixed so as to make the utensil 100 more aesthetic and entertain the user of the utensil 100. Graphic 126 is affixed on top of button 106, graphic 128 is affixed on top of button 108 and graphic 130 is affixed on top of button 110. The pushing of a button results in the playing of an audio file pertaining to the graphic on that button. Pushing button 106 results in the playing of an aircraft sound since graphic 126 shows an airplane. Pushing button 108 results in the playing of a train sound since graphic 128 shows a train. Pushing button 110 results in the playing of a car sound since graphic 130 shows a car. Orifice 112 allows for sound from a speaker located within bottom portion 102 to pass through.

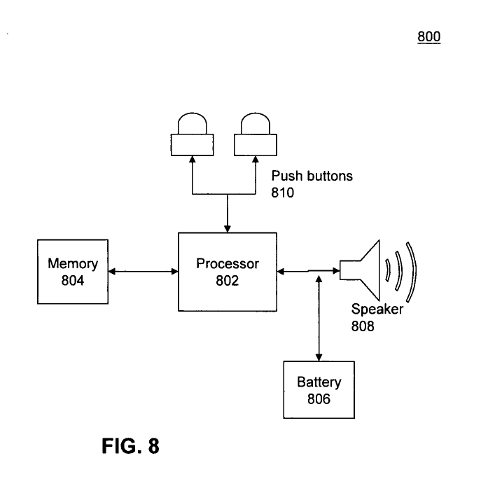

The utensil 100 may also include an electrical system (such as electrical system 800 in FIG. 8) that includes a memory 804 for storing audio data, a speaker 808 for playing the audio data and at least one activator (such as buttons 810) for activating the speaker 808 to play the audio data. The activator may include one or more buttons (such as buttons 106, 108 and 110 in FIG. 1 or buttons 810 in FIG. 8) that each comprise a simple push-button mechanism that completes a circuit when the button is pushed, thereby activating a process such as playing a sound. The electrical system 800 of the utensil 100 may further include a processor 802 connected to the one or more buttons 810, wherein the processor 802 activates playing of the audio data via the speaker 808 when at least one button 810 is pushed. Additionally, when activating the speaker 808 to play the audio data, the processor 802 reads the audio data from the memory 804. The electrical system 800 of the utensil 100 may further include a battery 806 for powering the electrical system 800.

In an embodiment of the present invention, the memory 804 on which audio data is stored can be ROM or read-only memory, which is computer memory on which data has been prerecorded. Once data has been written onto a ROM chip, it cannot be removed and can only be read. ROM retains its contents even when the computer is turned off. A variation of a ROM is a PROM (programmable read-only memory). PROMs are manufactured as blank chips on which data can be written with a special device called a PROM programmer.

In another embodiment of the present invention, the memory 804 on which audio data is stored can be EEPROM or electrically erasable programmable read-only memory. EEPROM is a special type of PROM that can be erased by exposing it to an electrical charge. Like other types of PROM, EEPROM retains its contents even when the power is turned off. EEPROM is similar to flash memory (sometimes called flash EEPROM). The principal difference is that EEPROM requires data to be written or erased one byte at a time whereas flash memory allows data to be written or erased in blocks. In another embodiment of the present invention, the memory 804 on which audio data is stored can be flash memory, which is a special type of EEPROM that can be erased and reprogrammed in blocks instead of one byte at a time.

In an embodiment of the present invention, the audio data that is stored in memory 804 can be a standard sound file stored in a conventional sound file format, such as Audio Interchange File Format, WAV format, MIDI format or MP3 format. In another embodiment of the present invention, each audio data file represents a sound pertaining to a particular vehicle, such as an airplane, a train or an automobile. Alternatively, each audio data file represents a sound pertaining to a particular animal, such as a dog, a duck or a cat. In another embodiment of the present invention, the speaker 808 for playing the audio data can be a small commercial off-the-shelf speaker such as a piezo-electric speaker.

In one embodiment of the present invention, the processor 802 of the electrical system 800 of the utensil 100 is a silicon chip that controls the logic of the electrical system 800. The processor 802 may be any commercially available microprocessor that can perform the functions necessary for the present invention and may be located on one or more printed circuit boards. The processor 802 activates playing of the audio data via the speaker 808 when at least one button 810 is pushed. The processor 802 may read the audio data from the memory 804 before playing the audio data.

In another embodiment of the present invention, the battery 806 for powering the electrical system 800 may comprise a standard commercially available alkaline battery, such as an AA size or an AAA size battery that ranges from 1.5 volts to 9 volts each. Alternatively, the battery 806 may be any commercially available silver oxide or lithium battery providing from 1.5 to 3 volts. In another alternative, the battery 806 may be a nickel cadmium battery, a nickel metal hydride battery, a lithium ion battery, or a zinc air battery. Removable cap 104 located in bottom portion 102 of the utensil 100 allows for the battery 806 of the electrical system 800 to be inserted or removed from within the bottom portion 102.

In an embodiment of the present invention, graphic 122, as well as graphics 126, 128 and 130, comprise a sticker or adhesive element composed of a paper or plastic-like substance having adhesive disposed on one side and a graphic picture on the other. In another embodiment of the present invention, the graphic 122, is manufactured into the substance comprising portion 120. In yet another embodiment of the present invention, the graphic 122 includes a film or similar element containing an image, wherein the film is disposed between layers of the substance comprising portion 120.

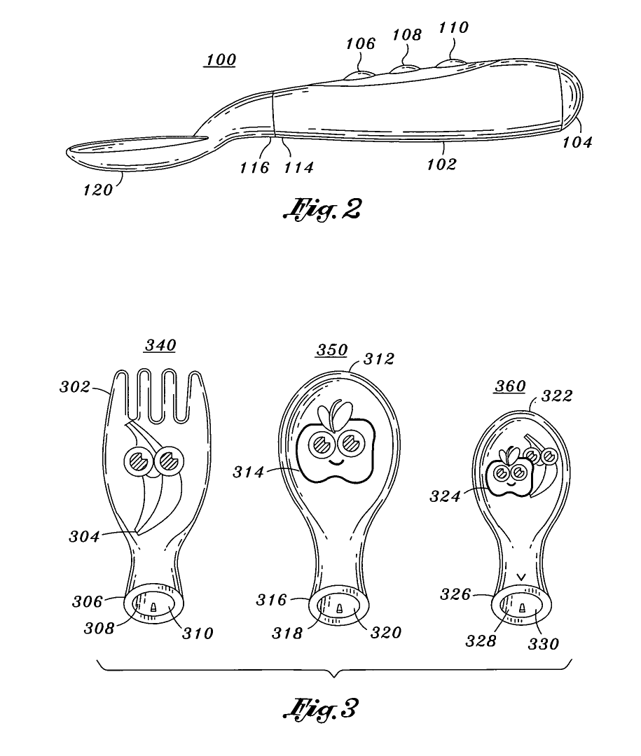

FIG. 2 is an illustration of a side view of the eating utensil 100 of FIG. 1. The figure shows the bottom portion 102 including side views of buttons 106, 108 and 110. FIG. 2 further shows the concave basin-shaped (or spoon) portion 120 of the upper portion 116 connected at the junction 114 with the bottom portion 102. Also shown is the removable cap 104 located in bottom portion 102 of the utensil 100, which allows for the battery of the electrical system to be inserted or removed from within the bottom portion 102.

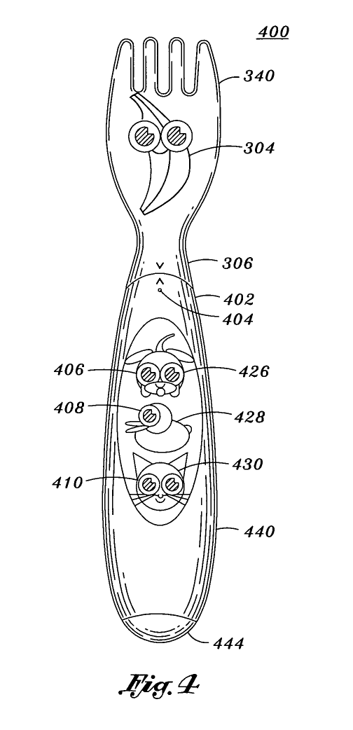

FIG. 3 is an illustration of a frontal view of various attachments that can be appended to an eating utensil 100, according to one embodiment of the present invention. Attachment 340 includes a portion 302 with two or more prongs or tines for pitching food, such as a fork. The portion 302 includes a graphic 304 that serves to make the attachment 340 more aesthetic and entertain or focus the attention of the child eating from the utensil 100. The attachment 340 is detachable and is secured onto bottom portion 102 of the utensil 100 via an orifice 308 located at end 306 of the attachment 340. The inside diameter 310 of orifice 308 of attachment 340 presses or clamps onto an end of bottom portion 102 so as to secure the attachment 340 onto the bottom portion 102.

Attachment 350 includes a concave basin-shaped portion 312 for holding food. The concave basin-shaped portion 312 is shaped like a spoon and is useful for scooping or picking up solid or liquid food for feeding to a person or child. The concave basin-shaped portion 312 includes a graphic 314 that serves to make the attachment 350 more aesthetic and entertain or focus the attention of the child eating from the utensil 100. The attachment 350 is detachable and is secured onto bottom portion 102 of the utensil 100 via an orifice 318 located at end 316 of the attachment 350. The inside diameter 320 of orifice 318 of attachment 350 presses or clamps onto an end of bottom portion 102 so as to secure the attachment 350 onto the bottom portion 102. Attachment 360 is a smaller version of attachment 350 and includes a concave basin-shaped portion 322 shaped like a spoon. The portion 322 includes a graphic 324. The attachment 360 is detachable and is secured onto bottom portion 102 via an orifice 328 located at end 326 of the attachment 360. The inside diameter 330 of orifice 328 of attachment 360 presses or clamps onto an end of bottom portion 102 so as to secure the attachment 360 onto the bottom portion 102.

FIG. 4 is an illustration of a frontal view of another eating utensil 400 including an audio component, according to one embodiment of the present invention. Like FIG. 1, FIG. 4 shows the upper portion 306 of the utensil 400 includes a fork-shaped portion 340 for pitching food. The portion 340 includes a graphic 304 that serves to make the utensil 400 more aesthetic. In one embodiment of the present invention, the portion 340 is manufactured from a soft, elastic and/or flexible material.

The upper portion 306 is detachable and is secured onto bottom portion 402 of the utensil 400. The bottom portion 402 of the utensil 400 includes buttons 406, 408 and 410. On top of each button, a graphic is affixed so as to make the utensil 400 more aesthetic. Graphic 426 is affixed on top of button 406, graphic 428 is affixed on top of button 408 and graphic 430 is affixed on top of button 410. The pushing of a button results in the playing of an audio file pertaining to the graphic on that button. Pushing button 406 results in the playing of a dog sound since graphic 426 shows a dog. Pushing button 408 results in the playing of a duck sound since graphic 428 shows a duck. Pushing button 410 results in the playing of a cat sound since graphic 430 shows a cat. Orifice 404 allows for sound from a speaker located within bottom portion 402 to pass through. Removable cap 444 located in bottom portion 402 of the utensil 400 allows for a battery to be inserted or removed from within the bottom portion 402.

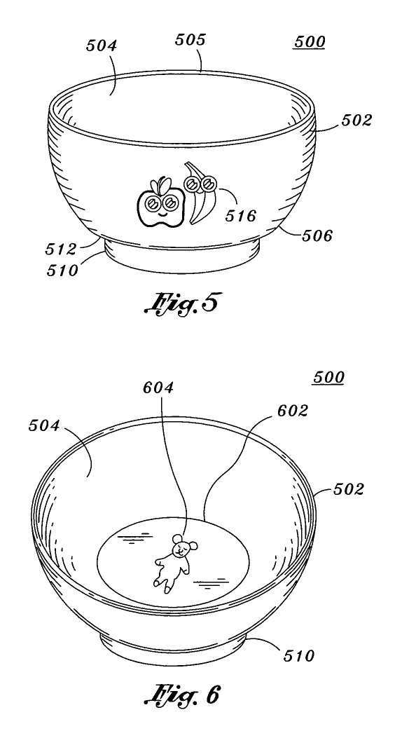

FIG. 5 is an illustration of a side perspective view of a bowl 500 including a reward component, according to one embodiment of the present invention. FIG. 5 shows the bowl 500 having a rim 505, an inner concave portion 504 for holding liquid or solid food and an outer surface 502 including a graphic 516 (similar to graphic 122) serving an ornamental purpose. A rounded flat ring 510 attaches to the bottom end 506 of bowl 500 at juncture 512. The ring 510 at the bottom end 506 provides a flat surface such that bowl 500 can rest securely on a flat surface such as a table without tipping over. The components of bowl 500 may be composed of plastic or other numerous organic synthetic or processed materials that can be thermoplastic or thermosetting polymers of high molecular weight and that can be made into objects, films, or filaments.

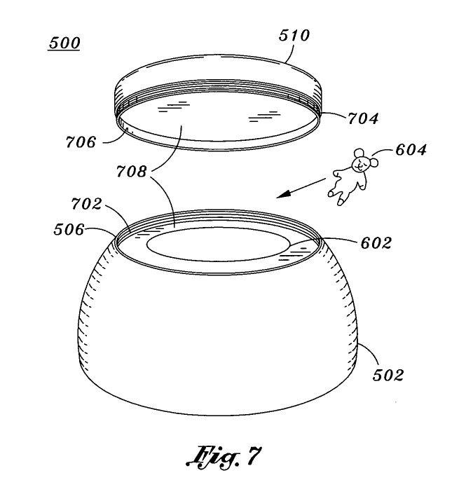

FIG. 6 is an illustration of a top perspective view of the bowl 500 of FIG. 5. FIG. 6 shows the outer surface 502 and the inner surface 504 of the bowl 500. Also shown is a clear (i.e., see-through), rounded and planar surface 602 at the bottom of the inner surface 504 of the bowl 500. Underneath the planar surface 602, but within bowl 500, is a prize or reward 604 in the form of a doll or teddy bear. The reward 604 lies within ring 510, which is explained in greater detail below. The clear planar surface 602 allows the child to see the reward 604 underneath it when there is no opaque food in the bowl 500. Thus, when the bowl 500 is filled with opaque food, such as milk, tomato soup or rice, the child cannot see the reward 604. However, once the food is eaten, the child can see the reward 604, thereby providing the child with a goal of eating the food so that he may see and subsequently remove the reward 604 from the bowl 500.

FIG. 7 is an illustration of a bottom perspective view of the bowl 500 of FIG. 5 shown in a disassembled state. Bowl 500 includes a removable portion including outer ring 510 and threaded ring 706, which includes a threaded outer surface 704. The removable portion can be threaded or screwed into bowl 500 by screwing outer surface 704 into threaded ring 702 located in bottom end 506 of bowl 500. It is shown that when raised ring 706 is married or coupled to raised ring 702 by threading or screwing into each other, a space or cavity 708 is created. The cavity 708 is used to house the reward 604 within bowl 500 such that a child may view the reward 604 via clear, planar surface 602 when viewing the bowl 500 from the top. Using the features of bowl 500, a user can easily place a reward 604 within the bowl 500 by placing the reward within the cavity 708 and screwing outer surface 704 into threaded ring 702. The presence of the reward 604 within bowl 500 may motivate a child to finish his food, after which he may view the reward 604 via surface 602 and subsequently remove it by unscrewing outer surface 704 from threaded ring 702.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A utensil, comprising:
a portion for holding food;
a handle for holding the utensil;
a speaker for playing audio; and
at least one activator for activating the speaker to play audio.

2. The utensil of claim 1, wherein the portion for holding is removable.

3. The utensil of claim 2, wherein the utensil is any one of a fork and a spoon.

4. The utensil of claim 2, wherein the portion for holding food comprises a concave basin portion.

5. The utensil of claim 2, wherein the portion for holding food comprises two or more prongs for pitching food.

6. The utensil of claim 1, wherein the at least one activator comprises one or more buttons.

7. The utensil of claim 6, further comprising a processor connected to one or more buttons, wherein the processor activates playing of audio via the speaker when at least one button is pushed.

8. The utensil of claim 7, further comprising a memory for storing audio data, wherein the processor reads the audio data and plays it via the speaker when a button is pushed.

9. The utensil of claim 8, wherein the audio data comprises sounds made by a vehicle.

10. A utensil, comprising:
a portion for holding food;
a handle for holding the utensil;
a memory for storing audio data;
a speaker for playing the audio data; and
a processor for playing the audio data via the speaker when activated.

11. The utensil of claim 10, wherein the portion for holding is removable.

12. The utensil of claim 11, wherein the portion for holding food comprises a concave basin portion.

13. The utensil of claim 11, wherein the portion for holding food comprises two or more prongs for pitching food.

14. The utensil of claim 10, further comprising at least one button for instructing the processor to activate playing the audio data via the speaker when at least one button is pushed.

15. The utensil of claim 14, wherein the audio data comprises sounds made by a vehicle.

16. An apparatus for feeding a child, comprising:
a utensil for holding food; and
an electrical unit for playing audio when activated.

17. The apparatus of claim 16, wherein the utensil is any one of a spoon and a fork.

18. The apparatus of claim 16, wherein the electrical unit comprises a memory for holding audio data, a speaker for playing the audio data and at least one button for activating playing of the audio data via the speaker.

19. The apparatus of claim 18, wherein the electrical unit further comprises a processor for activating playing of the audio data via the speaker when at least one button is pushed.

20. The apparatus of claim 19, wherein the electrical unit further comprises a battery for providing power to the electrical unit.
